(19) United States
(12) Patent Application Publication
(10) Pub. No.: US 2020/0130942 A1
(43) Pub. Date: Apr. 30, 2020

(54) GUIDING DEVICE FOR LONG OBJECT

(71) Applicant: TSUBAKIMOTO CHAIN CO., Osaka-shi, Osaka (JP)

(72) Inventor: Takayuki Tetsuka, Osaka-shi (JP)

(73) Assignee: TSUBAKIMOTO CHAIN CO., Osaka-shi, Osaka (JP)

(21) Appl. No.: 16/606,901

(22) PCT Filed: Apr. 20, 2018
(86) PCT No.: PCT/JP2018/016292

§ 371 Date: Oct. 21, 2019

(30) Foreign Application Priority Data
Apr. 24, 2017 (JP) 2017-085462

(51) Int. Cl. B65G 15/48

(52) U.S. Cl. CPC B65G 15/48

(57) ABSTRACT

An elongated object guiding device includes an elongated protection guide portion, inner wheels, outer wheels, a first rail surface, a second rail surface, at least one divided portion, and a restriction guide. The outer wheels are located at positions different from those of the inner wheels in the longitudinal direction of the protection guide portion and located farther from the protection guide portion in the width direction than the inner wheels. The divided portion is configured by dividing the first rail surface and the second rail surface. The divided portion allows the inner wheels and the outer wheels to move along a curved portion. The restriction guide limits a range in which at least the inner wheels or the outer wheels moves away from the first rail surface and the second rail surface.

### TECHNICAL FIELD

The present invention relates to an elongated object guiding device that includes an elongated protection guide portion configured by links coupled to one another in series and guides an elongated object accommodated in the protection guide portion while protecting the elongated object.

### BACKGROUND ART

Such type of an elongated object guiding device includes an elongated protection guide portion that guides an elongated object while guiding the elongated object. The protection guide portion is configured by links pivotally coupled to one another in series. The elongated object is accommodated in an accommodation space defined in the protection guide portion.

The protection guide portion is arranged on the body of an apparatus to which the elongated object guiding device is coupled such that the middle part of the protection guide portion is provided with a curved portion. In this case, a movable body that moves back and forth in the longitudinal direction is coupled to one end (movable end) of the protection guide portion in the longitudinal direction. The other end (fixed end) of the protection guide portion in the longitudinal direction is fixed to the body of the apparatus.

Patent Documents 1 and 2 disclose examples of elongated object guiding devices including a protection guide portion having pairs of rollers spaced apart from each other in the longitudinal direction. Each pair of rollers is arranged on the opposite sides of the protection guide portion in the width direction. The elongated object guiding device disclosed in Patent Document 1 includes an elongated guide rail that guides the protection guide portion. The guide rail guides the protection guide portion when the movable end of the protection guide portion moves back and forth as the curved portion on the middle part of the protection guide portion moves. The pairs of rollers roll on the surface of the guide rail. Thus, even if part of the protection guide portion droops, the drooping part is prevented from contacting the other parts of the protection guide portion.

Further, in the elongated object guiding device disclosed in Patent Document 2, when the rollers roll on an installation surface, the protection guide portion is prevented from contacting the installation surface. Magnets are spaced apart from one another in the longitudinal direction and fixed to the outer circumferential surface of the protection guide portion. The elongated object guiding device disclosed in Patent Document 2 includes a plate located above a part between the movable end and the curved portion. In this device, the magnets are magnetically attached to the plate to prevent the protection guide portion from drooping.

### PRIOR ART DOCUMENTS

### Patent Documents

Patent Document 1: German Patent Application Publication No. 102012111542

Patent Document 2: German Utility Model No. 202013012408

### SUMMARY OF THE INVENTION

### Problems that the Invention is to Solve

However, in the elongated object guiding device of Patent Documents 1 and 2, when the curved portion sequentially moves as the movable body moves, the protection guide portion bulges outward due to swinging-up of links. When the protection guide portion bulges outward, the bulging part may interfere with the other members. Thus, in order to avoid the interference of the bulging part with the other members, a sufficient space needs to be provided between the protection guide portion and the other members. When the protection guide portion interferes with the other members, the interference wears and damages the protection guide portion, thereby reducing the life of the elongated object guiding device. However, when a sufficient space is provided between the protection guide portion and the other members to avoid interference of the protection guide portion with the other members, the elongated object guiding device will be enlarged.

It is an object of the present invention to provide an elongated object guiding device that limits outward bulging of a protection guide portion caused by swinging-up of links in the vicinity of a curved portion.

### Means for Solving the Problem

Means and operational advantages for solving the above-described problem will now be described.

An elongated object guiding device that solves the above-described problem includes an elongated protection guide portion including links pivotally coupled to one another in series and an accommodation space capable of accommodating an elongated object, the protection guide portion having one end that configures a fixed end and another end that configures a movable end, inner wheels arranged on opposite sides of the protection guide portion in a width direction intersecting a longitudinal direction, outer wheels arranged on the opposite sides of the protection guide portion in the width direction, the outer wheels being located at positions different from those of the inner wheels in the longitudinal direction of the protection guide portion and located farther from the protection guide portion in the width direction than the inner wheels, a first rail surface on which the inner wheels are able to roll, a second rail surface on which the outer wheels are able to roll, at least one divided portion configured by dividing the first rail surface and the second rail surface, the at least one divided portion allowing the inner wheels and the outer wheels to move along a curved portion provided between the movable end and the fixed end in a process in which the movable end moves, and a restriction guide that limits a range in which at least the inner wheels or the outer wheels moves away from the first rail surface and the second rail surface.

In this structure, the elongated object is arranged in the accommodation space. When the movable end moves, the protection guide portion protects and guides the elongated object while moving the curved portion. At this time, the inner wheels roll on the first rail surface, and the outer wheels roll on the second rail surface. This limits drooping of the protection guide portion. In addition, even if swinging-up of the links causes the protection guide portion to act to bulge outward in the vicinity of the curved portion, at least the inner wheels or the outer wheels strikes the restriction guide and is restricted from further moving away from the rail surfaces. This prevents the protection guide portion from excessively bulging outward in the vicinity of the curved portion. For example, when a restriction member that restricts a protection guide portion is provided in order to prevent the protection guide portion from bulging outward, the protection guide portion may wear by sliding over the restriction member. If, in order to avoid interference of the outwardly bulging part of the protection guide portion with the other members, a sufficient space is provided between the protection guide portion and the other members, the elongated object guiding device is enlarged. However, this structure limits outward bulging of the protection guide portion caused by swinging-up of the links in the vicinity of the curved portion while avoiding the reduction in the life of the elongated object guiding device or the enlargement of the elongated object guiding device that is caused by wear of the protection guide portion.

In the above-described elongated object guiding device, it is preferred that the restriction guide be arranged over at least a range in which the curved portion moves.

In this structure, in the movement range of the curved portion, movement of at least the inner wheels or the outer wheels away from the rail surfaces is limited to a predetermined range by the restriction guide. This effectively limits bulging of the protection guide portion in the vicinity of the curved portion, which occurs when the links swing up. It is preferred that the restriction guide be arranged over the entire movement range of the movable end. Portions other than the curved portion act to bulge outward in the protection guide portion, which is relatively short. In this structure, such bulging can be limited.

In the above-described elongated object guiding device, it is preferred that the inner wheels and the outer wheels be located at positions shifted toward an inner circumference of the protection guide portion.

In this structure, the restriction guide can be arranged proximate to the protection guide portion in the thickness direction of the protection guide portion. This reduces the size of the elongated object guiding device in the thickness direction.

In the above-described elongated object guiding device, it is preferred that the divided portion include at least one guide surface capable of guiding at least the inner wheels or the outer wheels at least in part of a process in which the inner wheels and the outer wheels move along the curved portion.

In this structure, in at least part of a process of moving along the curved portion, at least the inner wheels or the outer wheels is supported by the guide surface. Thus, at least the inner wheels or the outer wheels can be supported in a long range. In addition, since at least the inner wheels or the outer wheels is supported in part of the process of moving along the curved portion, chattering of the protection guide portion in the vicinity of the curved portion is limited.

In the above-described elongated object guiding device, it is preferred that the at least one guide surface include a first guide surface guiding the inner wheels and a second guide surface guiding the outer wheels and the second guide surface be deviated from the first guide surface in the longitudinal direction toward a protrusion side of the curved portion.

In this structure, when the movable end moves in the protruding direction of the curved portion, the inner wheels are temporarily supported by the first guide surface in the process of reaching the divided portion and moving along the curved portion. Further, even when the inner wheels are no longer supported by the first guide surface, the outer wheels are supported by the second rail surface or the second guide surface. This avoids a sudden large pivot of the links at the curved portion. The links pivot relatively slowly at the curved portion. This relatively reduces the force of outwardly bulging the protection guide portion, which is caused by the swinging-up of the links. For example, the impact of the inner wheels and the outer wheels when striking the restriction guide is relatively reduced.

It is preferred that the above-described elongated object guiding device include a pair of rail members each including the first rail surface and the second rail surface. In the above-described elongated object guiding device, it is preferred that the restriction guide be one of two restriction guides arranged in correspondence with the pair of rail members and that each of the restriction guides be configured by a flange located at a position of the corresponding rail member opposed to the first rail surface and the second rail surface.

In this structure, the first rail surface, the second rail surface, and the restriction guide are arranged on a single rail member. This reduces the number of components of the elongated object guiding device.

In the above-described elongated object guiding device, it is preferred that the first rail surface and the second rail surface include a sloped surface extending downward in a gravitational direction toward an end of the sloped surface, the sloped surface being located at ends of the first rail surface and the second rail opposite from a protrusion side of the curved portion in the longitudinal direction.

In this structure, even if the wheels passing through the divided portions among the inner wheels and the outer wheels move downward in the gravitational direction due to drooping of the protection guide portion, when the wheels end passing through the divided portions, the wheels can be guided toward the sloped surface and moved onto the guide rail surface smoothly. This reduces the frequency of collision between the wheels with the rails caused when the inner wheels or the outer wheels fail to move onto the rail surface.

### Effect of the Invention

The present invention can limit outward bulging of a protection guide portion caused by swinging-up of links in the vicinity of a curved portion.

### BRIEF DESCRIPTION OF THE DRAWINGS

FIG. 1 is a perspective view showing an elongated object guiding device according to an embodiment.

FIG. 2 is a side view showing the elongated object guiding device with one of the guide rails removed.

FIG. 3 is a plan view showing the protection guide portion.

FIG. 4 is a perspective view showing the structure of the first link.

FIG. 5 is a front view showing the structure of the first link.

FIG. 6 is a perspective view showing the structure of the second link.

FIG. 7 is a front view showing the structure of the second link.

FIG. 8 is a perspective view showing a main part of the guide rail.

FIG. 9 is a partial cross-sectional view showing the elongated object guiding device.

FIG. 10 is a cross-sectional view taken along line 10-10 in FIG. 9.

FIG. 11 is a partial cross-sectional view showing the elongated object guiding device.

FIG. 12 is a side view illustrating an operation of the elongated object guiding device.

FIG. 13 is a side view illustrating an operation of the elongated object guiding device.

FIG. 14 is a side view illustrating an operation of the elongated object guiding device.

FIG. 15 is a side view illustrating an operation of the elongated object guiding device.

FIG. 16 is a side view illustrating an operation of the elongated object guiding device.

FIG. 17 is a side view illustrating an operation of the elongated object guiding device.

### MODES FOR CARRYING OUT THE INVENTION

An elongated object guiding device according to an embodiment will now be described.

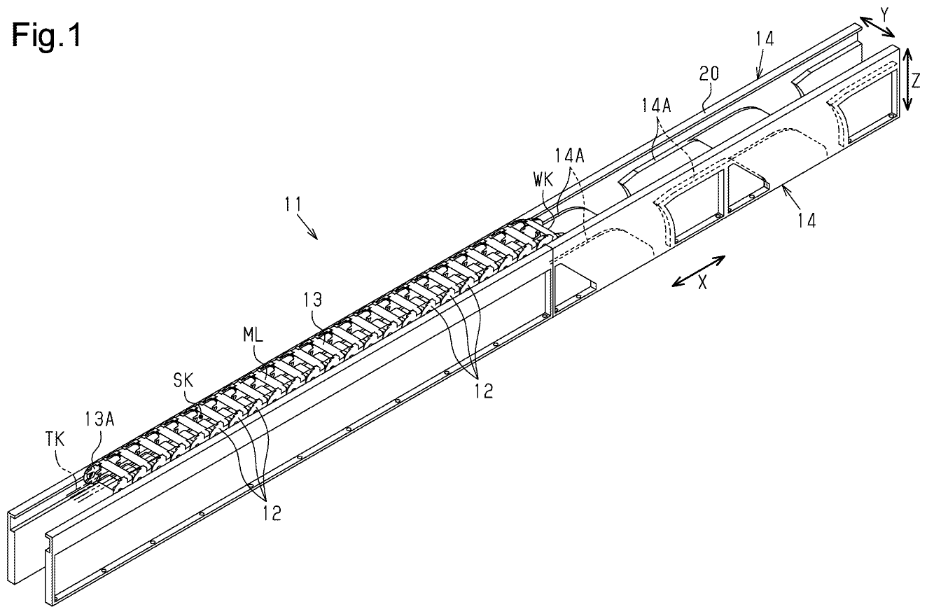

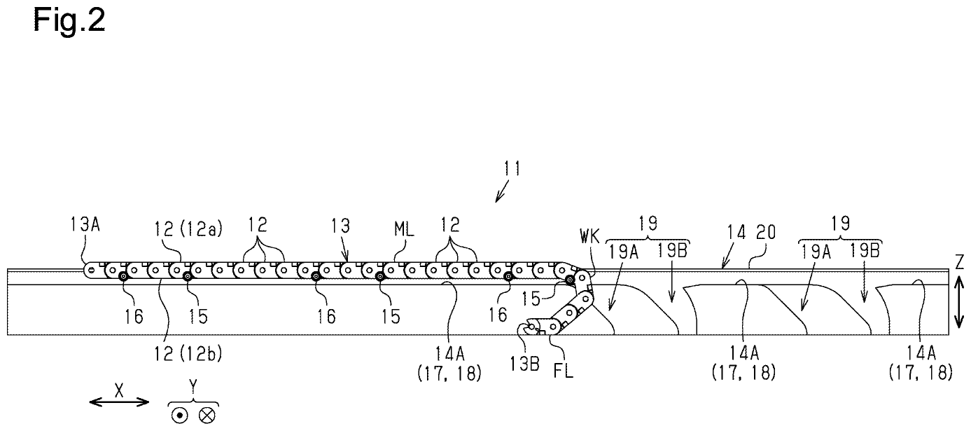

As shown in FIG. 1, an elongated object guiding device 11 includes an elongated protection guide portion 13. The protection guide portion 13 includes links 12, which are coupled to one another in series such that the links 12 can pivot within a range of a predetermined angle. The protection guide portion 13 includes an accommodation space SK, which extends in the longitudinal direction such that the accommodation space SK can accommodate an elongated object TK. One end of the protection guide portion 13 in the longitudinal direction configures a movable end 13A. The other end of the protection guide portion 13 in the longitudinal direction configures a fixed end 13B (refer to FIG. 2).

Further, as shown in FIG. 1, the elongated object guiding device 11 includes a pair of elongated guide rails 14, which serve as rail members that can guide the protection guide portion 13. The fixed end 13B of the protection guide portion 13 is fixed to the bottom of an intermediate position of the guide rail 14 in a longitudinal direction X. The protection guide portion 13 is coupled to a part between the two guide rails 14 in a state in which a curved portion WK, which is U-shaped in a side view, is arranged at the middle part between the fixed end 13B and the movable end 13A. A part of the protection guide portion 13 extending substantially straight between the movable end 13A and the curved portion WK is referred to as a movable-side straight part ML. The movable-side straight part ML is guided such that the movable-side straight part ML can move along the edges (upper edges in FIGS. 1 and 2) of the two guide rails 14. In the elongated object guiding device 11 of the present embodiment, the distance between the two guide rails 14 in a width direction Y is slightly longer than the width of the protection guide portion 13 in the width direction Y. Thus, the protection guide portion 13 hardly slides on the guide rails 14.

As shown in FIGS. 1 and 2, the protection guide portion 13, which is coupled to the two guide rails 14, includes the above-described movable-side straight part ML, the curved portion WK, and a fixed-side straight portion FL (refer to FIGS. 2 and 11), which extends from the curved portion WK to the fixed end 13B. As described above, the movable-side straight part ML is guided along the guide rails. The elongated object guiding device 11 is coupled to, for example, the body (not shown) of a device to which the elongated object guiding device 11 is attached. The device to which the elongated object guiding device 11 is attached includes, for example, a movable body (not shown) that can move back and forth along a straight path over a predetermined movement range. The movable body coupled to the movable end 13A moves back and forth in the longitudinal direction X while moving the curved portion WK of the protection guide portion 13 in the longitudinal direction X. The elongated object guiding device 11 uses the protection guide portion 13 to guide the elongated object TK, which is accommodated in the accommodation space SK, while protecting the elongated object TK. The energy of power or the like necessary for movement of the movable body is conveyed through the elongated object TK to the movable body from the device to which the elongated object guiding device 11 is attached.

The elongated object TK may be, for example, an electric cable for supplying electricity to the movable body (not shown), an optical fiber cable for transmitting a signal to the movable body (not shown), a hose for supplying gas (for example, air) or liquid (for example, water or oil) to the movable body (not shown), or a bendable elongated articulated member. A fastener (not shown) fixed to a fixed part (not shown) of the device to which the elongated object guiding device 11 is attached is pivotally coupled to the link 12 located at one end of the protection guide portion 13 in the longitudinal direction X. A coupler (not shown) is coupled to the link 12 located at the other end of the protection guide portion 13 in the longitudinal direction X such that the coupler can pivot relative to the movable body.

In the present embodiment, in the elongated object guiding device 11, the longitudinal direction of the two guide rails 14 is referred to as the “longitudinal direction X.” The direction that is orthogonal to the longitudinal direction X and in which the two guide rails 14 face is referred to as the “width direction Y” The direction that is orthogonal to both the longitudinal direction X and the width direction Y is referred to as the “thickness direction Z.” In the present embodiment, the elongated object guiding device 11 is arranged horizontally such that the thickness direction Z is set in parallel to a gravitational direction. However, the elongated object guiding device 11 may be arranged in any orientation, for example, vertically in which the longitudinal direction X is parallel to the gravitational direction or horizontally in which the width direction Y is parallel to the gravitational direction, in accordance with the purpose of use, the specification and structure of the device to which the elongated object guiding device 11 is attached, or the like.

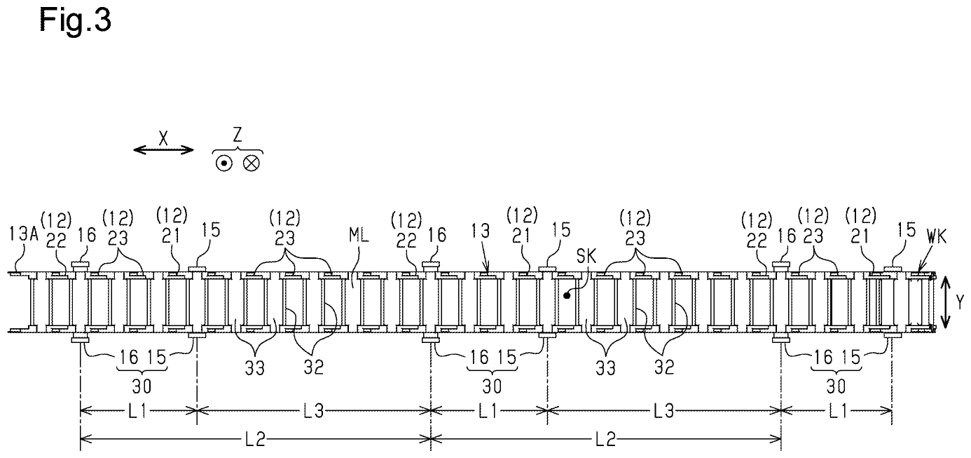

As shown in FIG. 3, the protection guide portion 13 includes pairs of inner wheels 15 (inner rollers) and pairs of outer wheels 16 (outer rollers), which are spaced apart from each other by a predetermined interval in the longitudinal direction X. Each pair of inner wheels 15 and each pair of outer wheels 16 are arranged on the opposite sides of the protection guide portion 13 in the width direction Y. The pairs of outer wheels 16 are located outward from the pairs of inner wheels 15 in the width direction Y. That is, the pairs of inner wheels 15 are located outward from the protection guide portion 13 in the width direction Y, and the pairs of outer wheels 16 are located outward from the pairs of inner wheels 15 in the width direction Y. Further, the inner wheels 15 and the outer wheels 16 are located at different positions in the longitudinal direction of the protection guide portion 13. In the present embodiment, as shown in FIG. 3, the inner wheels 15 and the outer wheels 16 are alternately arranged and spaced apart from each other in the longitudinal direction of the protection guide portion 13.

As shown in FIG. 3, the links 12 include first links 21, each of which includes a pair of inner wheels 15, second links 22, each of which includes a pair of outer wheels 16, and normal links 23, which do not include the wheels 15 or 16. The links 12 configuring the protection guide portion 13 of the present embodiment are configured by the first links 21, the second links 22, and the normal links 23, which are coupled to one another in a predetermined order in the longitudinal direction X. A link group including a single first link 21, a single second link 22, and a predetermined number of normal links 23 is set as a single unit. The protection guide portion 13 is configured by repeatedly coupling the units of the link group.

As shown in FIG. 3, a pair of inner wheels 15 and a pair of outer wheels 16 are arranged with a pitch of a distance L1 in the longitudinal direction of the protection guide portion 13 to configure a wheel group 30, which is a single unit. As shown in FIG. 3, the distance L1 (pitch) is a value corresponding to the pitch between the inner wheels 15 and the outer wheels 16 when two normal links 23 are coupled to each other between the first link 21 and the second link 22, which configure a single wheel group 30.

Further, as shown in FIG. 3, a distance L2, which is a pitch between the wheel groups 30 in the longitudinal direction X, is longer than the distance L1 (L2>L1). As shown in FIG. 3, the distance L2 is a value corresponding to the pitch of the outer wheels 16 when nine normal links 23 are coupled to one another between the two second links 22 that belong to two wheel groups 30 adjacent to each other in the longitudinal direction X. As shown in FIG. 3, the distance L2 is three times larger than the distance L1, which is the pitch between the inner wheels 15 and the outer wheels 16 configuring a wheel group 30 (L2=3×L1). Further, a distance L3, which is a pitch between the inner wheels 15 of one of the two adjacent wheel groups 30 and the outer wheels 16 of the other wheel group 30, is longer than the distance L1 (L3>L1). In the present embodiment, the distance L3 is two times larger than the distance L1. The distance L1 may be changed as long as a condition described later in relation to the length of the curved portion WK (curve length) is satisfied. Further, the distances L2 and L3 may be changed as long as drooping of the protection guide portion 13 can be limited.

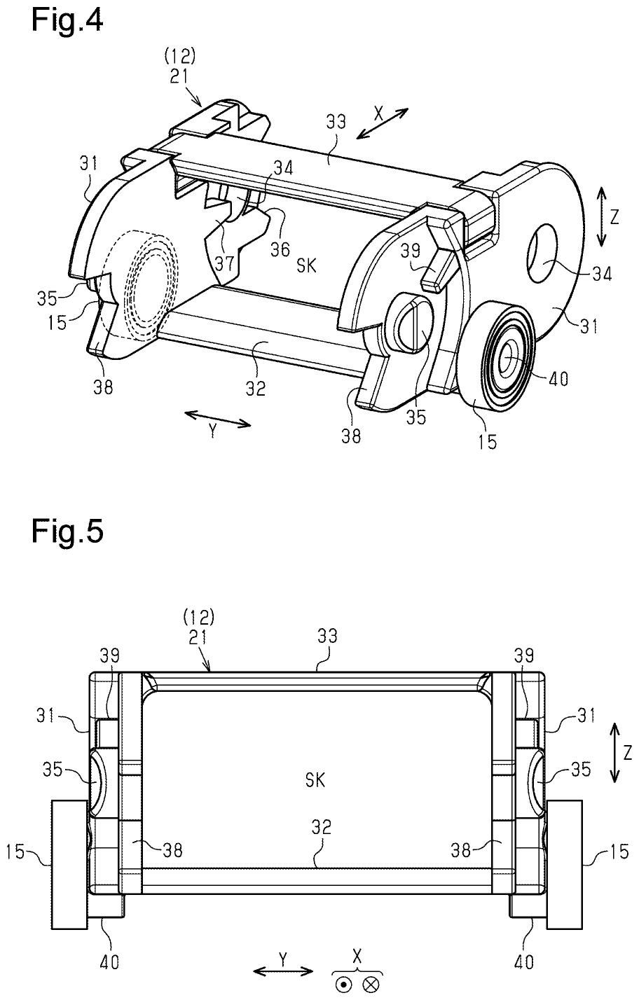

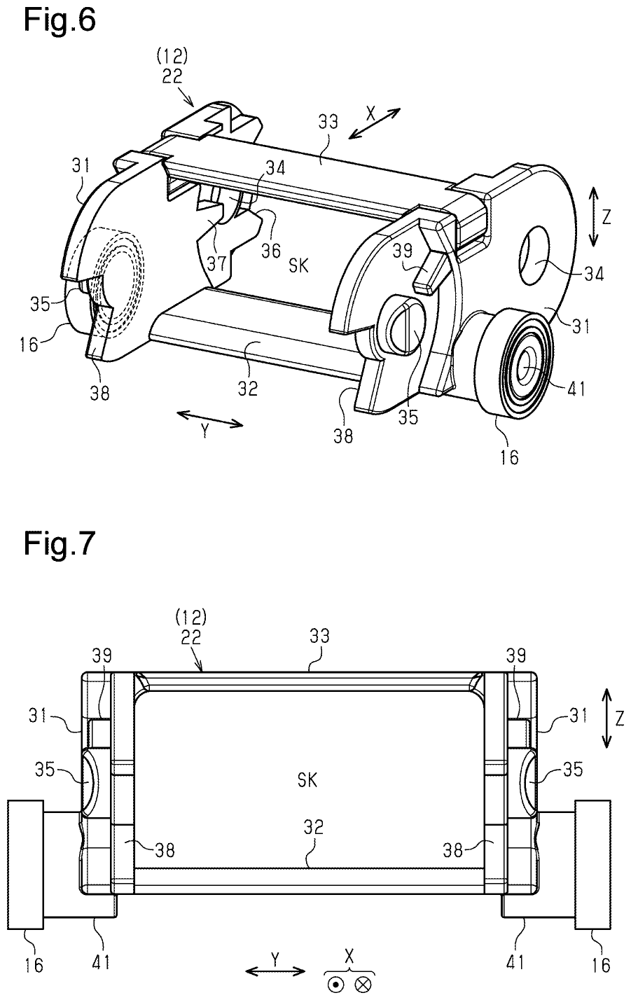

The structure of each of the links 21 to 23, which configure the protection guide portion 13, will now be described with reference to FIGS. 4 to 7. FIGS. 4 and 5 show the structure of the first link 21, and FIGS. 6 and 7 show the structure of the second link 22. The structure of the normal link 23 corresponds to a structure in which part of the structure of the inner wheel 15, the outer wheel 16 or the like (refer to FIGS. 4 to 7) is removed from the first link 21 or the second link 22. Thus, in the following description, the normal link 23 will not be described. Instead, the structure of the first link 21 shown in FIGS. 4 and 5 and the structure of the second link 22 shown in FIGS. 6 and 7 will be described. In addition, the structure common to each of the links 21 to 23 will be described as the link 12, and the structure unique to each of the links 21 and 22 will be separately described. Further, the direction in which the links 12 are coupled to one another in a straight manner without being pivoted corresponds to the longitudinal direction X in FIGS. 1, 2, and the like. Thus, in the following description, the direction in which the links 12 are coupled to one another in a straight manner without being pivoted will also be referred to as a “coupling direction X.”

As shown in FIGS. 4 to 7, each of the links 12 (21 to 23) includes a pair of link plates 31, a first coupling portion 32, and a second coupling portion 33. The two link plates 31 have a substantially rectangular plate shape and are opposed to each other in the width direction Y. The first coupling portion 32 has a substantially rectangular plate shape and couples the two link plates 31 to each other. The second coupling portion 33 has a substantially rectangular plate shape and couples the two link plates 31 to each other at a position facing the first coupling portion 32. The first coupling portion 32 is formed integrally with the two link plates 31. The second coupling portion 33 is coupled to the two link plates 31 in a removable manner. The first coupling portion 32 may be coupled to the two link plates 31 in a removable manner.

As shown in FIGS. 4 to 7, the space surrounded by the link plates 31, the first coupling portion 32, and the second coupling portion 33 to extend in the coupling direction X configures the accommodation space SK. The accommodation space SK extends in the longitudinal direction of the protection guide portion 13 with the links 12 coupled to one another. The accommodation space SK accommodates elongated objects TK. Each link 12 can be provided with, for example, a partition (not shown) that can divide the accommodation space SK into some sections in the width direction Y to separate the elongated objects TK from each other.

As shown in FIGS. 4 and 6, each link plate 31 is substantially shaped as a rectangular plate with rounded ends in the longitudinal direction X. Each link plate 31 includes a first end in the longitudinal direction X having a circular coupling hole 34, which extends through the link plate 31. Each link plate 31 includes a second end in the longitudinal direction X having an outer surface provided with a columnar coupling projection 35, which pivotally fits into the coupling hole 34 of a different link plate 31, which is adjacent to the link plate 31 in the coupling direction X.

The inner surface of each link plate 31 is provided with an inner recess 36, which is substantially sectoral, at a position corresponding to the first end of the link plate 31 in the longitudinal direction X. The inner surface of each link plate 31 is also provided with an inner projection 37, which is substantially cuboid, such that the coupling hole 34 is located between the inner recess 36 and the inner projection 37 in the longitudinal direction X. The outer surface of each link plate 31 is provided with an outer recess 38, which is substantially sectoral, at a position corresponding to the second end of the link plate 31 in the longitudinal direction X. The outer surface of each link plate 31 is also provided with an outer projection 39, which is substantially cuboid, such that the coupling projection 35 is located between the outer recess 38 and the outer projection 39.

As shown in FIG. 2, when two links 12 that are adjacent to each other in the coupling direction X are referred to as links 12a and 12b, the coupling projection 35 of the link 12b is fitted into the coupling hole 34 of the link 12a. The outer projection 39 of the link 12b is accommodated in the inner recess 36 of the link 12a. Further, the inner projection 37 of the link 12a is accommodated in the outer recess 38 of the link 12b. The inner projection 37 and the outer projection 39 are respectively slidable in the outer recess 38 and the inner recess 36 within a predetermined angle range (for example, by 45 degrees) in the circumferential direction of the coupling hole 34. The predetermined angle range is a pivoting range (pivotal angular range) of two links 12 adjacent to each other in the coupling direction X.

More specifically, the inner projection 37 can slide (pivot) only within a range from a state in which a first side surface of the inner projection 37 is in contact with a first side surface of the outer recess 38 to a state in which a second side surface of the inner projection 37 is in contact with a second side surface of the outer recess 38. In the same manner, the outer projection 39 can slide (pivot) only within a range from a state in which a first side surface of the outer projection 39 is in contact with a first side surface of the inner recess 36 to a state in which a second side surface of the outer projection 39 is in contact with a second side surface of the inner recess 36. In this case, the inner recess 36, the inner projection 37, the outer recess 38, and the outer projection 39 of each link 12 limit the pivoting range of adjacent links 12 such that the adjacent links 12 pivot between a straight state in which the adjacent links 12 are arranged straight and a bent state in which the adjacent links 12 are bent.

As shown in FIGS. 4 and 5, the two inner wheels 15 are rotationally coupled to the lower parts of the opposite outer surfaces of the first link 21 in the width direction Y, respectively. More specifically, the first link 21 includes two support shafts 40, which protrude outward perpendicularly from the outer surfaces of the link plates 31, respectively. Each support shaft 40 is located below a substantially central position of the corresponding link plate 31 in the longitudinal direction X. The inner wheels 15 are rotationally coupled to the support shafts 40, respectively. As shown in FIG. 5, the two inner wheels 15 are located outward from the outer surfaces of the link plates 31 in the width direction Y, respectively.

As shown in FIGS. 6 and 7, the two outer wheels 16 are rotationally coupled to the lower parts of the opposite outer surfaces of the second link 22 in the width direction Y, respectively. More specifically, the second link 22 includes two support shafts 41, which protrude outward perpendicularly from the outer surfaces of the link plates 31, respectively. Each support shaft 41 is located below a substantially central position of the corresponding link plate 31 in the longitudinal direction X. The two outer wheels 16 are rotationally coupled to the two support shafts 41, respectively. As shown in FIG. 7, the two outer wheels 16 are located outward from the outer surfaces of the two link plates 31 in the width direction Y, respectively. Further, when the links 12 are coupled to one another, the two outer wheels 16 are located outward from the two inner wheels 15 of the first link 21 in the width direction Y, respectively. More specifically, the support shafts 41 protrude longer than the support shafts 40 from the outer surfaces of the link plates 31 in the width direction Y. Thus, the outer wheels 16 supported by the support shafts 41 are located outward from the inner wheels 15 supported by the support shafts 40 in the width direction Y by an amount in which the support shafts 41 protrude longer than the support shafts 40.

As shown in FIGS. 5 and 7, the inner wheels 15 and the outer wheels 16 have the same outer diameter. The inner wheels 15 and the outer wheels 16 are located at the same height relative to the links 21 and 22. Thus, when the links 12 are coupled to one another, the inner wheels 15 and the outer wheels 16 are located at the same height relative to the protection guide portion 13. As long as the inner wheels 15 and the outer wheels 16 are able to roll respectively on rail surfaces 17 and 18, the inner wheels 15 and the outer wheels 16 may have different outer diameters. Further, as long as the inner wheels 15 and the outer wheels 16 are able to roll respectively on the rail surfaces 17 and 18, the inner wheels 15 and the outer wheels 16 may be located at different heights. Furthermore, the first rail surface 17 and the second rail surface 18 do not have to be arranged so as to define a common surface 14B and may be arranged at different heights.

In the present embodiment, the inner wheel 15 is deviated outward in the width direction Y from the outer surface of the link plate 31 by an amount corresponding to the width of the inner wheel 15. The outer wheel 16 is deviated outward in the width direction Y from the inner wheel 15 by an amount corresponding to the width of the outer wheel 16. Further, the first rail surface 17 has a rail width that has substantially the same length as the width of the inner wheel 15. The second rail surface 18 has a rail width that has substantially the same length as the width of the outer wheel 16. Thus, the first rail surface 17 and the second rail surface 18 are adjacent to each other in the width direction Y. Accordingly, although the inner wheel 15 and the outer wheel 16 are arranged on the outer side of the protection guide portion 13 in the width direction Y, the width of the elongated object guiding device 11 is relatively reduced. The positions of the link plate 31, the inner wheel 15, and the outer wheel 16 in the width direction Y simply need to be deviated outward in this order in the width direction Y. At least two of the link plate 31, the inner wheel 15, and the outer wheel 16 may be located to partially overlap each other in the width direction Y. At least two of the link plate 31, the inner wheel 15, and the outer wheel 16 may be spaced apart from each other in the width direction Y.

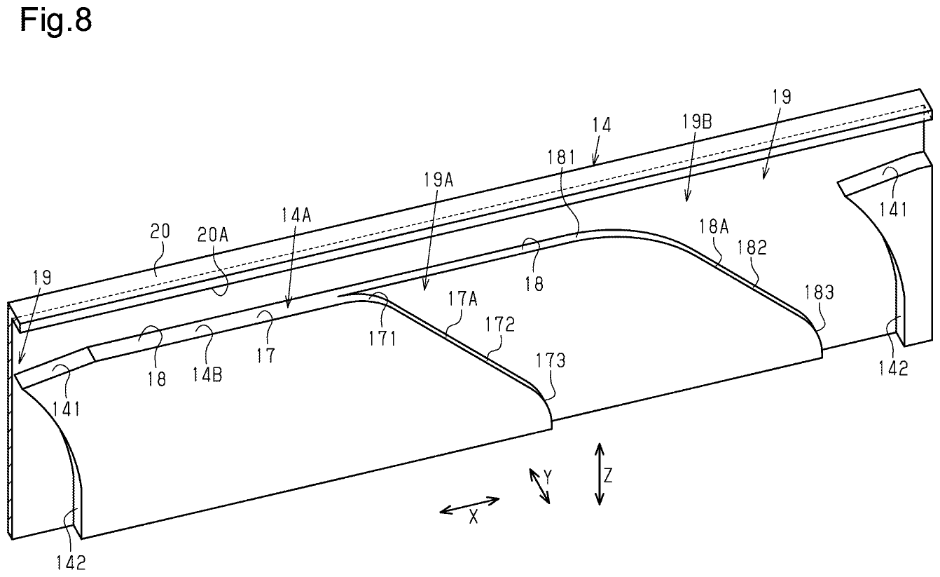

The structures of the two guide rails 14 will now be described with reference to FIGS. 2 and 8. As shown in FIGS. 2 and 8, the two guide rails 14 each include a guide rail surface 14A. The guide rail surface 14A extends in the longitudinal direction X such that pairs of inner wheels 15 and pairs of outer wheels 16 are able to roll on the guide rail surface 14A. Each guide rail surface 14A includes the first rail surface 17, on which the inner wheels 15 are able to roll, and the second rail surface 18, on which the outer wheels 16 are able to roll. In the present embodiment, the inner wheels 15 and the outer wheels 16 have the same diameter and are located at the same position in the thickness direction Z relative to the side part of the protection guide portion 13. Thus, the two rail surfaces 17 and 18 are located on the same height in the guide rail 14. Further, the two rail surfaces 17 and 18 define a single common surface 14B (refer to FIG. 8), which has a width that is equal to the widths of the two rail surfaces 17 and 18 partially in the longitudinal direction X.

As shown in FIG. 2, the guide rail 14 includes divided portions 19, which are configured by dividing the rail surfaces 17 and 18 at multiple positions. The number of the divided portions 19 of each guide rail 14 is, for example, equal to the number N of the wheel groups 30, which are arranged in the protection guide portion 13, or a number that is smaller than the number N of the wheel groups 30 by one. In the present embodiment, the number of the divided portions 19 of each guide rail 14 is a number (for example, 2) that is smaller than the number N (for example, 3) of the wheel groups 30 by one. Each divided portion 19 includes a first rail surface divided portion 19A, which divides the first rail surface 17 in the longitudinal direction X, and a second rail surface divided portion 19B, which divides the second rail surface 18 in the longitudinal direction X.

The first rail surface divided portion 19A has a function of allowing the inner wheels 15 to move in the thickness direction Z along the curved portion WK when the first link 21 reaches the curved portion WK (refer to FIGS. 13 to 17). The second rail surface divided portion 19B has a function of allowing the outer wheels 16 to move in the thickness direction Z along the curved portion WK when the second link 22 reaches the curved portion WK (refer to FIGS. 16 and 17).

As shown in FIG. 8, each first rail surface divided portion 19A includes an extension surface 17A, which is continuous with the divided first rail surface 17. The extension surface 17A downwardly extends toward the protrusion side (right side in FIG. 8) of the curved portion WK in the longitudinal direction X. The extension surface 17A includes a first guide surface 171, which is gently curved from the end of the divided first rail surface 17, an inclined surface 172, which is inclined at a predetermined angle, and an extreme end surface 173, which is curved at a steeper angle than the inclined surface 172. The extension surface 17A can guide and support the inner wheels 15 at least on the first guide surface 171. The curvedness and the inclination angle of the first guide surface 171 are set to values in accordance with a movement path of the inner wheels 15 at the curved portion WK. Thus, when the first link 21 moves at the curved portion WK, the inner wheels 15 are supported by the first guide surface 171 during part of a process in which the inner wheels 15 move along the curved portion WK.

As shown in FIG. 8, each second rail surface divided portion 19B includes an extension surface 18A, which is continuous with the divided second rail surface 18. The extension surface 18A downwardly extends toward the protrusion side (right side in FIG. 8) of the curved portion WK in the longitudinal direction X. The extension surface 18A includes a second guide surface 181, which is gently curved from the end of the divided second rail surface 18, an inclined surface 182, which is inclined at a predetermined angle, and an extreme end surface 183, which is curved at a steeper angle than the inclined surface 182. The extension surface 18A can guide and support the outer wheels 16 at least on the second guide surface 181. The curvedness and the inclination angle of the second guide surface 181 are set to values in accordance with a movement path of the outer wheels 16 at the curved portion WK. Thus, when the second link 22 moves at the curved portion WK, the outer wheels 16 are supported by the second guide surface 181 during part of a process in which the outer wheels 16 move along the curved portion WK.

As shown in FIG. 8, the divided second rail surface 18 extends longer than the divided first rail surface 17 toward the protrusion side of the curved portion WK in the longitudinal direction X. Thus, the second rail surface divided portion 19B is narrower than the first rail surface divided portion 19A in the longitudinal direction X. Further, the second rail surface divided portion 19B is located closer to the protrusion side of the curved portion WK in the longitudinal direction X than the first rail surface divided portion 19A. Thus, the extension surface 18A, which corresponds to the outer wheels 16, is deviated from the extension surface 17A, which corresponds to the inner wheels 15, toward the protrusion side of the curved portion WK in the longitudinal direction X. The difference between the length of the divided second rail surface 18 and the length of the divided first rail surface 17 is approximately equal to the distance L1, which corresponds to the pitch between the inner wheel 15 and the outer wheel 16 that belong to the same wheel group 30.

In addition, as shown in FIG. 8, the end (left end in FIG. 8) of the guide rail surface 14A in the longitudinal direction X located opposite from the protrusion side of the curved portion WK is provided with a sloped surface 141. The sloped surface 141 extends downward in the gravitational direction toward the end of the sloped surface 141. Thus, even when the wheels 15 and 16 passing through the divided portion 19 among the inner wheels 15 and the outer wheels 16 are no longer supported by the guide rail surface 14A and the corresponding part of the protection guide portion 13 droops and moves downward in the gravitational direction, the wheels 15 and 16 pass through the divided portion 19 and then can be guided to the sloped surface 141 and moved smoothly onto the guide rail surface 14A.

Further, as shown in FIG. 8, the guide rail 14 includes a third guide surface 142, which has the form of a curved recess surface recessed in the protruding direction of the curved portion WK. The third guide surface 142 is located downward from the sloped surface 141. That is, each divided portion 19 includes the third guide surface 142, which is located downward from the sloped surface 141 and has the form of a curved recess surface recessed in the protruding direction of the curved portion WK. The outer wheels 16 are guided and supported by the third guide surface 142 when located in the vicinity of the fixed-side straight portion FL of the curved portion WK. The third guide surface 142 supports and guides the outer wheel 16 in a section immediately before downward movement of the outer wheel 16 along the curved portion WK ends. Alternatively, the third guide surface 142 supports and guides the outer wheel 16 in a section immediately after upward movement of the outer wheel 16 along the curved portion WK starts.

The distance L1, the positions of the extension surfaces 17A and 18A, and the position of the third guide surface 142 are set such that at least the inner wheel 15 or the outer wheel 16 at the curved portion WK is supported by the rail surfaces 17 and 18 or by the guide surfaces 171, 181, and 142. The distance L1 is set to be smaller than the circumferential length along the inner circumferential surface of the curved portion WK.

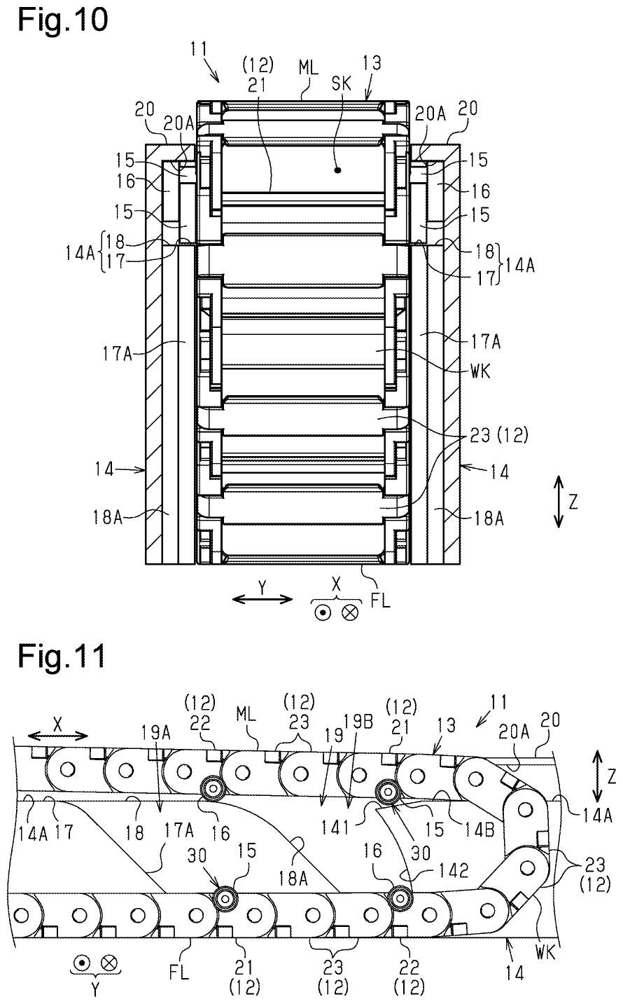

Further, as shown in FIGS. 8 to 10, a restriction guide 20 extends in the longitudinal direction X from a position of each guide rail 14 opposed to the rail surfaces 17 and 18. The restriction guide 20 is configured by a flange extending in the longitudinal direction X at the position of the guide rail 14 opposed to the rail surfaces 17 and 18. In the present embodiment, the restriction guide 20 is arranged over the entire guide rail 14 in the longitudinal direction X. Thus, the restriction guide 20 is arranged over the entire movement path of the movable end 13A. That is, the restriction guide 20 is arranged over the entire region of the guide rail 14 where the movable-side straight part ML can be located.

As shown in FIGS. 8 to 10, the restriction guide 20 is formed integrally with the guide rail 14, which is a rail member having the rail surfaces 17 and 18. The distance between the rail surfaces 17 and 18 and a restriction surface 20A is larger than the diameter (outer diameter) of the wheels 15 and 16. This allows the wheels 15 and 16 to move in the thickness direction Z within a range of the distance between the rail surfaces 17 and 18 and the restriction surface 20A. The distance in which the wheels 15 and 16 can move in the thickness direction Z is set to, for example, a value less than or equal to half of the pitch of the link 12. Particularly, in the present embodiment, the distance in which the wheels 15 and 16 can move in the thickness direction Z is set to a value within a range between a value that is greater than or equal to one and a half times larger than the diameters of the wheels 15 and 16 and a value that is less than or equal to two times larger than the diameters of the wheels 15 and 16. This distance is set to be a value that reduces bulging of the protection guide portion 13 to a minimum while allowing the bulging, which is caused by the swinging-up of the links 12 needed to keep the curved portion WK at a U-shape in a side view.

Even when the links 12 swing up to bulge the protection guide portion 13 in the vicinity of the curved portion WK and the wheels 15 and 16 act to move away from the rail surfaces 17 and 18, the wheels 15 and 16 strike the restriction surface 20A. Thus, the restriction guide 20 restricts a range in which the wheels 15 and 16 move away from the rail surfaces 17 and 18. The restriction guide 20 allows for necessary swinging-up of the links 12. Thus, the curved portion WK can easily form a U-shape in a side view.

In addition, as shown in FIGS. 2, 9, and 11, the inner wheels 15 and the outer wheels 16 are located at positions shifted toward the inner circumference of the protection guide portion 13. That is, the protection guide portion 13 is configured to reduce the amount in which the protection guide portion 13 projects from the guide rails 14 in the thickness direction Z. Alternatively, the protection guide portion is configured such that the protection guide portion does not project from the guide rails 14 in the thickness direction Z. In this manner, the elongated object guiding device 11 is reduced in size in the thickness direction Z. In the present embodiment, as shown in FIG. 11, when the wheels 15 and 16 are in contact with the guide rail surface 14A, the outer circumferential surface (upper surface) of the protection guide portion 13 is substantially flush with the upper surface of the guide rail 14. The elongated object guiding device 11 is configured to reduce the amount in which the protection guide portion 13 projects from the guide rails 14 to less than or equal to half of the dimension (thickness) of the protection guide portion 13 in the thickness direction Z in a restricted state in which the wheels 15 and 16 are in contact with the restriction surface 20A.

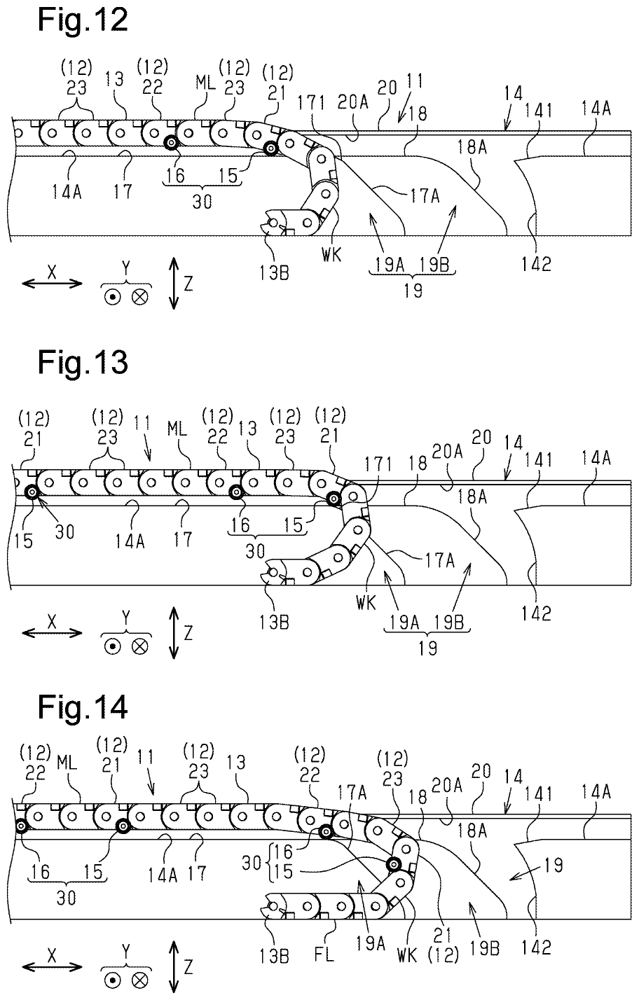

The operation of the elongated object guiding device 11 will now be described with reference to, for example, FIGS. 12 to 17. To couple the elongated object guiding device 11 to the body of the apparatus, the two guide rails 14 and the fixed end 13B of the protection guide portion 13 are fixed to the body of the apparatus or the installation surface. Further, the movable body is coupled to the movable end 13A of the protection guide portion 13. The operation of an example in which the movable body moves from one end to the other end of the movement range in the elongated object guiding device 11 will now be described. As shown in FIG. 12, when the movable body is moving from one end toward the other end, pairs of inner wheels 15 and pairs of outer wheels 16, which are spaced apart from each other in the longitudinal direction of the protection guide portion 13, are supported respectively by the first rail surface 17 and the second rail surface 18. This limits drooping of the movable-side straight part ML, which is located between the movable end 13A of the protection guide portion 13 and the curved portion WK.

As shown in FIG. 12, when the movable end 13A (refer to FIG. 2) moves in the protruding direction of the curved portion WK (hereinafter also referred to as “first direction”), the protection guide portion 13 moves and the inner wheel 15 and the outer wheel 16 move in the first direction. The protruding direction (first direction) of the curved portion WK corresponds to the rightward direction in FIG. 2. First, when the first link 21 located at the head of the protection guide portion 13 in the movement direction reaches the curved portion WK, the first link 21 starts pivoting about the links 12 adjacent to the first link 21 in the front-rear direction such that the first link 21 is in a bent posture. Then, as shown in FIG. 13, while the inner wheel 15 of the first link 21 reaches the first rail surface divided portion 19A and gets separated from the first rail surface 17, the inner wheel 15 is guided and moved by the first guide surface 171 of the extension surface 17A temporarily. Thus, the inner wheel 15 is still supported by the first guide surface 171 at the first rail surface divided portion 19A temporarily. This limits swinging-up of the first link 21 provided with the inner wheel 15 and the links 12 adjacent to the first link 21 in the front-rear direction that occurs when the first link 21 and the links 12 reach the curved portion WK and then pivot.

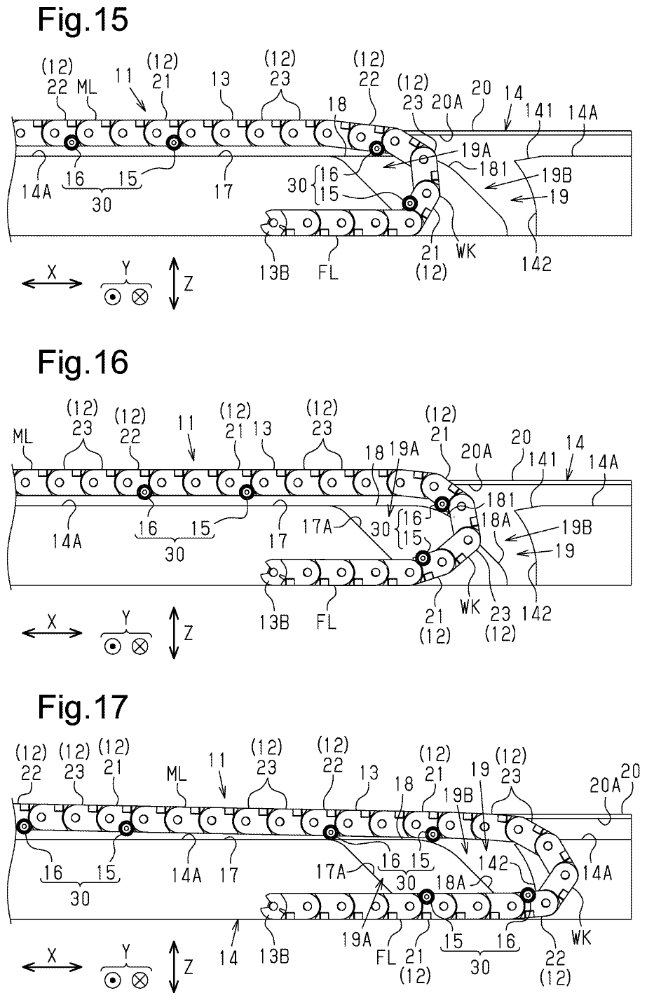

Then, as shown in FIG. 14, the inner wheel 15 is no longer supported by the first guide surface 171 at the first rail surface divided portion 19A and is separated from the extension surface 17A. At this time, the outer wheel 16 belonging to the same wheel group 30 as the inner wheel 15 moves on the second rail surface 18 (refer to FIGS. 14 and 15). That is, even if the inner wheel 15 is up in the air in the first rail surface divided portion 19A, the outer wheel 16 belonging to the same wheel group 30 as the inner wheel 15 is supported by the second rail surface 18.

Next, as shown in FIG. 16, when the second link 22 reaches the curved portion WK, the second link 22 starts pivoting about the links 12 adjacent to the second link 22 in the front-rear direction such that the second link 22 is in a bent posture. As a result, while the outer wheel 16 of the second link 22 is separated from the second rail surface 18 in the second rail surface divided portion 19B, the outer wheel 16 is supported by the second guide surface 181 temporarily. This easily keeps the curved portion WK at a U-shape curved form in a side view as compared to when all the wheels 15 and 16 of the first link 21 and the second link 22 belonging to the curved portion WK are not supported by any members.

Thereafter, the outer wheel 16 is separated from the extension surface 18A and falls in the air. As shown in FIG. 17, the outer wheel 16 is guided and supported by the third guide surface 142, which has the form of a curved recess surface, immediately before downward movement of the outer wheel 16 along the curved path ends. This easily keeps the curved portion WK U-shaped in a side view. At the point in time downward movement of the outer wheel 16 along the curved portion WK ends, the next inner wheel 15 configuring the subsequent wheel group 30 reaches the first rail surface divided portion 19A from the first rail surface 17. Thereafter, in the same manner, in the process in which the wheel group 30 moves along the curved portion WK, at least the inner wheel 15 or the outer wheel 16 is supported by any one of the rail surfaces 17 and 18 and the guide surfaces 171, 181, and 142. Thus, as compared to when the wheels 15 and 16 are not supported by any members, the curved portion WK can be easily kept at the curved form that is U-shaped in a side view. As shown in FIG. 17, in the fixed-side straight portion FL, the inner wheel 15 is located on the bottom of the first rail surface divided portion 19A and the outer wheel 16 is located on the bottom of the second rail surface divided portion 19B.

Thus, in the present embodiment, in the process in which the inner wheel 15 and the outer wheel 16 move along the curved portion WK, at least the inner wheel 15 or the outer wheel 16 is supported by any one of the rail surfaces 17 and 18 and the guide surfaces 171, 181, and 142. This easily keeps the curved portion WK at a curved U-shape in a side view. For example, in a structure in which only the rail surface is divided and no guide surface is provided, swinging-up of the links at the curved portion causes chattering of the protection guide portion at the curved portion or in the vicinity of the curved portion. This would cause the protection guide portion to bulge outward to a large extent. However, in the present embodiment, the wheels 15 and 16 are supported by the rail surfaces 17 and 18 and the guide surfaces 171, 181, and 142. Thus, the links 12 are gradually pivoted at the curved portion WK, thereby limiting the swinging-up of the links 12. Further, chattering of the protection guide portion 13 at the curved portion WK or in the vicinity of the curved portion WK is limited. This relatively reduces a force of outwardly bulging the protection guide portion 13 at the movable-side straight part ML, which results from swinging-up or the like of the links 12 in the vicinity of the curved portion WK.

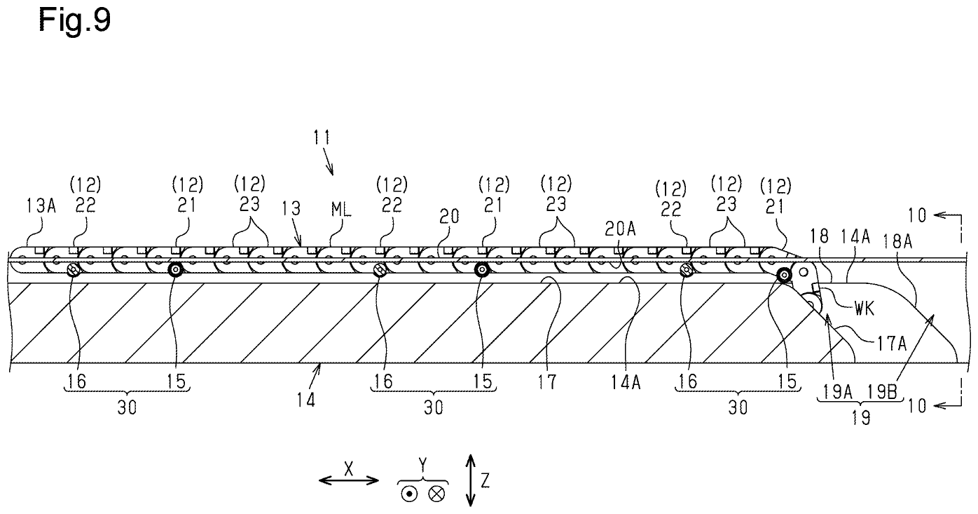

Although swinging-up or the like of the links 12 in the vicinity of the curved portion WK is limited, the swinging-up or the like still produces a force of outwardly bulging the protection guide portion 13 while being reduced. Thus, the protection guide portion 13 still acts to bulge outward (upward in FIGS. 9 to 17).

However, as shown in FIG. 9, when the protection guide portion 13 acts to bulge outward (upward in FIG. 9), the inner wheels 15 and the outer wheels 16 strike the restriction surface 20A of the restriction guide 20. This restricts the inner wheels 15 and the outer wheels 16 from further moving away from the rail surfaces 17 and 18 (upward in FIG. 9). That is, the restriction guide 20 limits the range in which the inner wheels 15 and the outer wheels 16 move away from the rail surfaces 17 and 18. As a result, outward bulging of the protection guide portion 13 is limited to a specified range.

Further, as shown in FIG. 17, among the inner wheels 15 and the outer wheels 16, the wheels 15 and 16 passing through the rail surface divided portions 19A and 19B slightly move downward as the protection guide portion 13 slightly droops in the divided portion 19. However, when the inner wheel 15 and the outer wheel 16 that have been slightly moved downward in the rail surface divided portions 19A and 19B end passing through the rail surface divided portions 19A and 19B, the inner wheel 15 and the outer wheel 16 can move onto the sloped surface 141 and then move onto the next rail surfaces 17 and 18.

A process in which the movable end 13A moves in a direction opposite to the protruding direction of the curved portion WK (hereinafter referred to as “second direction”) follows an order opposite from that during movement in the first direction. The second direction corresponds to the leftward direction in FIG. 13. That is, after the outer wheel 16 starts moving upward along the curved portion WK from the fixed-side straight portion FL (FIG. 17), the inner wheel 15 starts moving upward along the curved portion WK from the fixed-side straight portion FL in a delayed manner (FIG. 16). When the outer wheel 16 starts moving upward along the curved portion WK, the outer wheel 16 is first guided by the third guide surface 142 temporarily. Further, when the inner wheel 15 starts moving upward along the curved portion WK, the outer wheel 16 is supported by the second guide surface 181 immediately before ending moving upward along the curved path (FIG. 16). As soon as the inner wheel 15 starts moving upward in the first rail surface divided portion 19A, the outer wheel 16 moves onto the second rail surface 18. Thereafter, the inner wheel 15 moves upward in the air in the first rail surface divided portion 19A in a state in which the outer wheel 16 belonging to the same wheel group 30 is supported by the second rail surface 18 (FIGS. 14 and 15). Subsequently, the inner wheel 15 is supported by the first guide surface 171 (FIG. 13) and then moves onto the first rail surface 17 (FIG. 12). This gradually pivots the links 12 at the curved portion WK and easily keeps the curved portion WK U-shaped in a side view.

Also, when the movable end 13A moves in the second direction, the wheels 15 and 16 are supported by the rail surfaces 17 and 18. This limits drooping of the movable-side straight part ML of the protection guide portion 13. Further, even if swinging-up or the like of the links 12 in the vicinity of the curved portion WK causes the movable-side straight part ML of the protection guide portion 13 to act to move outward, the wheels 15 and 16 strike the restriction surface 20A of the restriction guide 20. This restricts further movement of the wheels 15 and 16. As a result, outward bulging of the movable-side straight part ML is limited to the specified range.

The present embodiment described above in detail has the following advantages.

(1) The elongated object guiding device 11 includes the inner wheels 15 and the outer wheels 16, which are respectively arranged on the opposite sides of the elongated protection guide portion 13 in the width direction Y. The elongated object guiding device 11 further includes the first rail surface 17, on which the inner wheels 15 are able to roll, the second rail surface 18, on which the outer wheels 16 are able to roll, and the divided portions 19. Each divided portion 19 is configured by dividing the first rail surface 17 and the second rail surface 18. Each divided portion 19 allows the inner wheels 15 and the outer wheels 16 to move along the curved portion WK, which is located at the middle part of the protection guide portion 13. Additionally, the elongated object guiding device 11 includes the restriction guides 20, which limit a movement range in which at least the inner wheels 15 or the outer wheels 16 move away from the first rail surface 17 and the second rail surface 18. When the movable end 13A moves, the protection guide portion 13 protects and guides the elongated object TK in the accommodation space SK while moving the curved portion WK, which is located at the middle part of the protection guide portion 13. At this time, the inner wheels 15 roll on the first rail surface 17, and the outer wheels 16 roll on the second rail surface 18. This limits drooping of the protection guide portion 13. In addition, even if swinging-up of the links causes the protection guide portion 13 to act to bulge outward in the vicinity of the curved portion WK, at least the inner wheels 15 or the outer wheels 16 strikes the restriction guide 20 and is restricted from further moving away from the rail surfaces 17 and 18. This prevents the protection guide portion 13 from excessively bulging outward in the vicinity of the curved portion WK. For example, when a restriction member that restricts a protection guide portion is provided in order to prevent the protection guide portion from bulging outward, the protection guide portion may wear by sliding over the restriction member. Further, in order to avoid interference of the outwardly bulging part of the protection guide portion with the other members, a sufficient space needs to be provided between the protection guide portion and the other members. However, in this case, the elongated object guiding device 11 may be enlarged. In the present embodiment, outward bulging of the protection guide portion 13 can be limited, thereby limiting wear of the protection guide portion or enlargement of the elongated object guiding device 11.

(2) The restriction guide 20 is arranged at least over the range in which the curved portion WK moves. Thus, in the movement range of the curved portion WK, movement of at least the inner wheels 15 or the outer wheels 16 away from the rail surfaces 17 and 18 is limited to the specified range by the restriction guide 20. This effectively limits bulging of the protection guide portion 13 in the vicinity of the curved portion WK, which occurs when the links 12 swing up. Particularly, in the present embodiment, the restriction guide 20 is arranged over the entire movement range of the movable end 13A. Portions other than the curved portion WK act to bulge outward in the protection guide portion 13, which is relatively short. Such bulging can be limited by the arrangement of the restriction guide 20 over the entire movement range of the movable end 13A.

(3) The inner wheels 15 and the outer wheels 16 are arranged at the locations shifted toward the inner circumference of the protection guide portion 13. Thus, the restriction guides 20 can be arranged proximate to the protection guide portion 13 in the thickness direction Z. Particularly, in the present embodiment, the inner wheels 15 and the outer wheels 16 are arranged such that the upper end surfaces of the guide rails 14 are substantially flush with or protrude from the upper surface of the protection guide portion 13. This reduces the size (height) of the elongated object guiding device 11 in the thickness direction Z.

(4) Each divided portion 19 includes the guide surfaces 171 and 181, which can respectively guide the inner wheels 15 and the outer wheels 16 at least in part of the process in which the inner wheels 15 and the outer wheels 16 move along the curved portion WK. Thus, when moving along the curved portion WK in the divided portion 19, the inner wheels 15 and the outer wheels 16 can be supported by the guide surfaces 171 and 181. Thus, the inner wheels 15 and the outer wheels 16 can be supported by the guide rails 14 in a long range. In addition, since the inner wheels 15 and the outer wheels 16 are supported in part of the process of moving along the curved portion WK, chattering and chatter noise of the protection guide portion 13 in the vicinity of the curved portion WK are limited.

(5) The guide surfaces include the first guide surface 171, which guides the inner wheels 15, and the second guide surface 181, which guides the outer wheels 16. The second guide surface 181 is deviated from the first guide surface 171 in the longitudinal direction X toward the protrusion side of the curved portion WK. Thus, when the movable end 13A moves in the protruding direction of the curved portion WK, the inner wheels 15 are temporarily supported by the first guide surface 171 in the process of reaching the first rail surface divided portion 19A and moving along the curved portion WK. Further, even when the inner wheels 15 are no longer supported by the first guide surface 171, the outer wheels 16 are supported by the second rail surface 18 or the second guide surface 181. This avoids a sudden large pivot of the links 12 at the curved portion WK. The links 12 pivot relatively slowly at the curved portion WK. This relatively reduces the force of outwardly bulging the protection guide portion 13, which is caused by the swinging-up of the links 12. As a result, the frequency of the inner wheels 15 and the outer wheels 16 striking the restriction guide 20 is relatively reduced. Further, the impact of the inner wheels 15 and the outer wheels 16 when striking the restriction guide 20 is relatively reduced. For example, this extends the life of the inner wheels 15 and the outer wheels 16 and reduces collision noise produced when the inner wheels 15 and the outer wheels 16 strike the restriction guide 20.

(6) A pair of rail members (guide rails 14), each of which includes the first rail surface 17 and the second rail surface 18, are provided. Each restriction guide 20 is configured by the flange formed at the position of the corresponding guide rail 14 opposed to the first rail surface 17 and the second rail surface 18. The flange includes the restriction surface 20A, which is opposed to the first rail surface 17 and the second rail surface 18. Thus, as compared to a structure in which the rail member including the first rail surface 17 and the second rail surface 18 is arranged separately from the rail member including the restriction guide 20, the number of components of the elongated object guiding device 11 is reduced.

(7) The first rail surface 17 and the second rail surface 18 include the sloped surface 141. The sloped surface 141 is located at the ends of the first rail surface 17 and the second rail surface 18 opposite from the protrusion side of the curved portion WK in the longitudinal direction X. The sloped surface 141 extends downward in the gravitational direction toward the end of the sloped surface 141. Thus, even if the wheels 15 and 16 passing through the divided portions 19 among the inner wheels 15 and the outer wheels 16 move downward in the gravitational direction due to drooping of the protection guide portion 13, when the wheels 15 and 16 end passing through the divided portions 19, the wheels 15 and 16 can be guided toward the sloped surface 141 and moved onto the guide rail surface 14A smoothly. This reduces the frequency of collision between the wheels 15 and 16 with the rails and limits collision noise caused when the inner wheels 15 and the outer wheels 16 fail to move onto the guide rail surface 14A.

The above-described embodiment may be modified as follows.

The first links 21, which include the inner wheels 15, and the second links 22, which include the outer wheels 16, may be alternately coupled to each other in the longitudinal direction X. However, when the wheel groups 30 are arranged in a relatively short pitch and the inner wheels 15 and the outer wheels 16 configuring each wheel group 30 are arranged in a relatively short pitch, the number of the divided portions 19 increases in proportion to the number of the wheel groups 30. This reduces the proportion of the regions of the guide rails 14 that can support the protection guide portion 13. Thus, it is preferred that the pitch of the wheel groups 30 have a proper length.

Restriction guides may be arranged at different heights in the thickness direction Z for the wheels 15 and 16. Further, the restriction guides may be configured by members that differ from the members configuring the rail surfaces.

The restriction guides may be arranged non-continuously in the longitudinal direction X of the rail surfaces. That is, the restriction guides may be divided at one position or at multiple positions at a middle part in the longitudinal direction X. In this case, as long as the movement range of at least one (more preferably, half) of the inner wheels and the outer wheels is limited regardless of the movement position of the movable end, a certain effect can be gained to limit bulging of the protection guide portion.

In the above-described embodiment, the first rail surface 17 and the second rail surface 18 are arranged on each rail member. Instead, the first rail surface, on which the inner wheels 15 roll, and the second rail surface, on which the outer wheels 16 roll, may be arranged on different rail members.

The rail surfaces 17 and 18 and the restriction guides 20 are arranged on a common member. Instead, the rail surfaces 17 and 18 and the restriction guides 20 may be arranged on different members.

In addition to guiding the portion of the protection guide portion 13 located between the movable end 13A and the curved portion WK using the rail surfaces and the restriction surfaces, a portion between the curved portion WK and the fixed end 13B may be guided using the rail surfaces and the restriction surfaces.

In the present embodiment, two paired inner wheels 15 are arranged at the same position in the longitudinal direction of the protection guide portion. Instead, two paired inner wheels 15 may be arranged at different positions in the longitudinal direction of the protection guide portion. In the present embodiment, two paired outer wheels 16 are arranged at the same position in the longitudinal direction of the protection guide portion. Instead, two paired outer wheels 16 may be arranged at different positions in the longitudinal direction of the protection guide portion. For example, one of the inner wheel 15 and the outer wheel 16 may be arranged only on one of the opposite sides of a single link in the width direction. Two links located relatively proximate to each other in the longitudinal direction X of the protection guide portion 13 may be separately provided with one and the other one of the two inner wheels 15. For example, two links adjacent to each other in the longitudinal direction X of the protection guide portion 13 may be separately provided with one and the other one of the two inner wheels 15. In this case, the positions of the divided portions 19 (rail surface divisions 19A and 19B) in the longitudinal direction X may be differentiated between the two guide rails 14.

In the above-described embodiment, the restriction guides are arranged over a longer range than the movement range of the curved portion WK. Instead, the restriction guides may be arranged only on the movement range of the curved portion WK.

Only one of the guide surfaces 171 and 181 may be arranged such that the guide surface can guide only the inner wheels 15 or the outer wheels 16 along the curved portion WK.

The inner wheels 15 and the outer wheels 16 may be located at positions overlapping each other in the width direction Y. In short, the outer wheels 16 simply need to be located farther from the protection guide portion 13 than the inner wheels 15.

The inner wheels 15 and the outer wheels 16 may be arranged at different locations in the thickness direction of the protection guide portion 13. Further, the outer diameter of the inner wheel 15 and the outer diameter of the outer wheel 16 may differ from each other. In these cases, the first rail surface and the second rail surface may be located at different positions in the thickness direction Z.

The number of the divided portions 19 is not limited to two. The number of the divided portions 19 may be changed in accordance with the length of the protection guide portion 13 (for example, 1 m to 100 m) or the number of the inner wheels 15 and the outer wheels 16 per unit length of the protection guide portion 13. For example, the number of the divided portions 19 may be one or may be three or more (for example, ten to one hundred).

At least the first or second guide surfaces may be configured by a curved surface that is curved along the movement path of the inner wheels and the outer wheels at the curved portion of the protection guide portion. In this case, at least the inner wheels or the outer wheels are able to roll and can be supported along the curved surface at the curved portion. Thus, chattering and chatter noise can be further limited in the vicinity of the curved portion of the protection guide portion.

The protection guide portion 13 may be made of synthetic plastic or metal. Alternatively, the protection guide portion 13 may be made of a mixture of a synthetic plastic member (component) and a metal member. As another option, part of the components of the protection guide portion 13 may be made of ceramic.

### DESCRIPTION OF REFERENCE CHARACTERS

11) Elongated Object Guiding Device; 12) Link; 13) Protection Guide Portion; 13A) Movable End; 13B) Fixed End; 14) Guide Rail serving as Rail Member; 14A) Guide Rail Surface; 14B) Common Surface; 15) Inner Wheel; 16) Outer Wheel; 17) First Rail Surface; 18) Second Rail Surface; 17A, 18A) Extension Surface; 19) Divided Portion; 19A) First Rail Surface Divided Portion; 19B) Second Rail Surface Divided Portion; 20) Restriction Guide; 20A) Restriction Surface; 21) First Link; 22) Second Link; 23) Normal Link; 141) Sloped Surface; 142) Third Guide Surface; 171) First Guide Surface; 181) Second Guide Surface; X) Longitudinal Direction; Y) Width Direction; Z) Thickness Direction; TK) Elongated Object; SK) Accommodation Space; WK) Curved Portion; ML) Movable-Side Straight Part; FL) Fixed-Side Straight Part

1. An elongated object guiding device comprising:
an elongated protection guide portion including links pivotally coupled to one another in series and an accommodation space capable of accommodating an elongated object, the protection guide portion having one end that configures a fixed end and another end that configures a movable end;
inner wheels arranged on opposite sides of the protection guide portion in a width direction intersecting a longitudinal direction;
outer wheels arranged on the opposite sides of the protection guide portion in the width direction, the outer wheels being located at positions different from those of the inner wheels in the longitudinal direction of the protection guide portion and located farther from the protection guide portion in the width direction than the inner wheels;
a first rail surface on which the inner wheels are able to roll;
a second rail surface on which the outer wheels are able to roll;
at least one divided portion configured by dividing the first rail surface and the second rail surface, the at least one divided portion allowing the inner wheels and the outer wheels to move along a curved portion provided between the movable end and the fixed end in a process in which the movable end moves; and
a restriction guide that limits a range in which at least the inner wheels or the outer wheels moves away from the first rail surface and the second rail surface, wherein
the restriction guide is arranged over at least a range in which the curved portion moves.

2. The elongated object guiding device according to claim 1, wherein the inner wheels and the outer wheels are located at positions shifted toward an inner circumference of the protection guide portion.

3. The elongated object guiding device according to claim 1, wherein the divided portion includes at least one guide surface capable of guiding at least the inner wheels or the outer wheels at least in part of a process in which the inner wheels and the outer wheels move along the curved portion.

4. The elongated object guiding device according to claim 3, wherein
the at least one guide surface includes a first guide surface guiding the inner wheels and a second guide surface guiding the outer wheels, and
the second guide surface is deviated from the first guide surface in the longitudinal direction toward a protrusion side of the curved portion.

5. The elongated object guiding device according to claim 1, comprising:
a pair of rail members each including the first rail surface and the second rail surface, wherein
the restriction guide is one of two restriction guides arranged in correspondence with the pair of rail members, and
each of the restriction guides is configured by a flange located at a position of a corresponding one of the rail members opposed to the first rail surface and the second rail surface.

6. The elongated object guiding device according to claim 1, wherein the first rail surface and the second rail surface include a sloped surface extending downward in a gravitational direction toward an end of the sloped surface, the sloped surface being located at ends of the first rail surface and the second rail opposite from a protrusion side of the curved portion in the longitudinal direction.

7. (canceled)
